(19) United States
(12) Patent Application Publication
(10) Pub. No.: US 2023/0034354 A1
(43) Pub. Date: Feb. 2, 2023

(54) FOAMED PLASTIC COMPOSITIONS

(71) Applicant: CARBIOS, SAINT-BEAUZIRE (FR)

(72) Inventor: MICHEL CHATEAU, RIOM (FR)

(21) Appl. No.: 17/786,588

(22) PCT Filed: Dec. 18, 2020
(86) PCT No.: PCT/EP2020/087250

§ 371 Date: Jun. 17, 2022

(30) Foreign Application Priority Data
Dec. 19, 2019 (EP) 19218116.2

(51) Int. Cl. C08J 9/224; C08J 9/12; C08J 11/10; C08J 3/22

(52) U.S. Cl. CPC C08J 9/224; C08J 9/122; C08J 11/105; C08J 3/22; C08J 2201/03; C08J 2203/02; C08J 2367/04

(57) ABSTRACT

The present invention relates to a foamed plastic composition comprising at least one polymer and at least one active agent, wherein said foamed plastic composition is at least partially coated with the active agent.

The present invention relates to new foamed plastic compositions that incorporate an active agent (such as a degrading enzyme) and uses thereof for manufacturing plastic products. The invention also relates to a process for producing such foamed plastic compositions.

### BACKGROUND

Different biodegradable plastic compositions have been developed in order to answer to plastic environmental issues and the piling up of plastic articles in landfill sites and in natural habitats, and to comply with restrictive legislation in particular about short-lived products (such as bags, packaging including trays, containers, bottles, agricultural films, textiles, etc.).

Most often, these plastic compositions contain polyester mixed with flours and/or starches derived from cereals. The use of flours and starches increase the rate of degradability of the final product. However, the addition of these compounds within the plastic composition may impair the mechanical properties of the plastic articles. Recently, a novel solution has been proposed wherein biological entities capable of degrading polyesters of the plastic articles are introduced in the plastic composition (WO 2013/093355; WO 2016/198652; WO 2016/198650; WO 2016/146540; WO 2016/062695; WO 2019/043145; WO 2019/043134).

However, there is still a need for solutions to optimize introduction of active agents, such as degrading enzymes, in the very structure of the plastic articles.

### SUMMARY OF THE INVENTION

The inventors have now developed plastic compositions wherein active agents (such as a degrading enzyme) have been introduced in the heart of the composition without submitting the active agent to temperatures that may impact their activity. More particularly, the inventors have discovered that it is possible to introduce active agents into the very structure of a foamed plastic composition by contacting said foamed plastic composition with active agents just after the foaming step, i.e., during the cooling of the foamed plastic composition. The inventors have developed plastic compositions, wherein active agents are coated not only on the surface of the foamed plastic composition, but also within the cell-structure of the foamed plastic composition (i.e., open and/or closed cells formed during the foaming step).

In this regard, it is an object of the invention to provide a foamed plastic composition comprising at least one polymer and at least one active agent wherein said foamed plastic composition is at least partially coated with the active agent. Particularly, the cell structures in the foamed plastic composition are at least partially coated with the active agent.

Said active agent is selected from biological entities having a degrading activity, preferably a polymer-degrading activity, and/or drugs and/or phytosanitary compounds and/or odorous molecules.

It is also an object of the invention to provide a foamed masterbatch comprising at least one polymer, and at least one active agent selected from enzyme and microorganism able to degrade a polymer, wherein said foamed masterbatch composition is at least partially coated with the active agent. Advantageously, said masterbatch comprises between 11% and 90% of biological entities by weight of the foamed plastic composition.

It is also an object of the invention to provide a process for incorporating an active agent within cell-structures of a foamed plastic composition comprising of at least one polymer, wherein the process comprises the steps of:
a. Foaming a plastic material comprising at least one polymer; and subsequently
b. Cooling the foamed plastic material by contacting said foamed plastic material with a cooling liquid comprising said active agent

Advantageously, said foaming step is performed at a temperature above the crystallization temperature (Tc) of at least one polymer of the plastic material, preferably at or above the melting temperature (Tm) of said polymer, and with a physical foaming agent and/or a chemical foaming agent, and preferably in an extruder, and said step of cooling is implemented less than 30 seconds after the foaming step, by contacting the plastic material with a cooling liquid at a temperature below the crystallization temperature (Tc) of at least one polymer of the plastic material, preferably below the glass transition temperature (Tg) of said polymer.

### DETAILED DESCRIPTION OF THE INVENTION

### Definitions

The present disclosure will be best understood by reference to the following definitions.

Within the context of the invention, the term “plastic material” refers to a mixture of thermoplastic polymer(s) and optionally additional compounds (e.g. additives such plasticizers, mineral or organic fillers), that may be used as raw material in the processes of the present invention. According to the invention, the term plastic material encompasses plastic articles coming from waste, as well as raw mixture of polymers. The plastic material is intended to be molten and mixed with additional compounds to form a plastic composition. In an embodiment, the plastic material is deprived of biological entities.

As used herein, the terms “plastic composition” designates a mixture of thermoplastic polymers, active agents and eventually additional compounds (e.g., additives such plasticizers, filler, etc.) obtained from plastic material and that may be used for manufacturing plastic products. According to the invention, a plastic composition encompasses masterbatch, preferably under a solid form. Most often, plastic compositions are conditioned under pellet form to be used for manufacturing plastic products. Alternatively, the plastic composition encompasses polymer-based matrix.

Within the context of the invention, the term “plastic article” or “plastic product” are used interchangeably and refer to any item or product made from plastic composition, such as plastic sheet, tray, tube, rod, profile, shape, massive block, fiber, etc. Preferably, the plastic article is a manufactured product, such as rigid or flexible packaging (bottle, trays, cups, etc.), agricultural films, bags and sacks, disposable items or the like, carpet scrap, fabrics, textiles, etc. Preferably, a plastic article comprises a mix of semi-crystalline and/or amorphous polymers. The plastic article may further contain additional substances or additives, such as plasticizers, minerals, organic fillers, dyes etc.

A “polymer” refers to a chemical compound or mixture of compounds whose structure is constituted of multiple repeating units (i.e. “monomers”) linked by covalent chemical bonds. Within the context of the invention, the term “polymer” refers to such chemical compound used in the composition of a plastic material, plastic composition or plastic product. As an example, synthetic polymers include polymers derived from petroleum oil, such as polyolefins, aliphatic or aromatic polyesters, polyamides, polyurethanes and polyvinyl chloride. In the context of the invention, polymer refers more particularly to thermoplastic polymer, i.e. a polymer that becomes moldable above a specific temperature and solidifies upon cooling. Within the context of the invention, the term thermoplastic polymer includes synthetic thermoplastic polymers, constituted of a single type of repeat unit (i.e., homopolymers) or of a mixture of different repeat units (i.e., copolymers).

Within the context of the invention, the term “polyester” refers to a polymer that contain the ester functional group in their main chain. Ester functional group is characterized by a carbon bound to three other atoms: a single bond to a carbon, a double bond to an oxygen, and a single bond to an oxygen. The singly bound oxygen is bound to another carbon. According to the composition of their main chain, polyesters can be aliphatic, aromatic or semi-aromatic. Polyester can be homopolymer or copolymer. As an example, polyethylene terephthalate is a semi-aromatic copolymer composed of two monomers: terephthalic acid and ethylene glycol.

In the context of the invention, “Tg”, “Tc”, and “Tm” respectively refer to the glass transition temperature, the crystallization temperature, and the melting temperature of a polymer. Such temperatures may be estimated by different analytical methods. For instance, Differential Scanning Calorimetry (DSC) or Differential thermal analysis (DTA) may be used for determining the Tg, Tc, and Tm of polymers. In the present disclosure, the Tg, Tc, and Tm of polymers have been measured with DSC.

In the context of the invention, “crystalline polymers” or “semi-crystalline polymers” refer to partially crystalline polymers wherein crystalline regions and amorphous regions coexist. The degree of crystallinity of a semi-crystalline polymer may be estimated by different analytical methods and typically ranges from 10 to 90%. For instance, Differential Scanning Calorimetry (DSC) or X-Ray diffraction may be used for determining the degree of crystallinity of polymers. Other techniques are also suited for estimating with less reliability polymer's crystallinity, such as X-ray Scattering (XS) (including Small Angle and Wide Angle XS) and Infrared Spectroscopy. In the present disclosure, the degrees of crystallinity have been measured with DSC. More particularly, the DSC measures were conducted as follow: a small quantity of the sample (several mg) is heated at a constant heating rate, from ambient or sub-ambient temperature to a high temperature that is higher than the melting temperature (Tm) of the polyester. The heat flow data is collected and plotted against temperature. The degree of crystallinity Xc (%) is calculated as:

$$Xc ( \% ) = \frac{( Δ Hf - Δ Hcc )}{wt * Δ Hf 100 \%} \times 100 \%$$

where
ΔH_{f} is the enthalpy of melting that can be determined by integrating the endothermic melting peak,
ΔH_{cc} is the enthalpy of cold crystallization and determined by integrating the exothermic cold crystallization peak,
wₜ the weight fraction of polyester in the plastic, and
ΔH_{f,100%} is the enthalpy of melting for a fully crystalline polymer and can be found in literature. As an example, ΔH_{f,100%} of PET is taken from literature as 125.5 J/g (Polymer Data Handbook, Second Edition, Edited by James E. Mark, OXFORD, 2009). According to the literature, ΔH_{f,100%} of PLA is equal to 93 J/g (Fisher E. W., Sterzel H. J., Wegner G., Investigation of the structure of solution grown crystals of lactide copolymers by means of chemical reactions, Kolloid Zeitschrift & Zeitschrift fur Polymere, 1973, 251, p 980-990).

The error margin of the degree of crystallinity is about 10%. Accordingly, a degree of crystallinity of about 25% corresponds to a degree of crystallinity between 22.5% and 27.5%.

Foamed Plastic Composition

The inventors have shown that it is possible to produce a foamed plastic composition comprising at least one active agent coated on the surface of and within the foamed plastic composition, wherein the active agents are introduced in the plastic composition without mixing said active agent with the plastic composition in molten state. More particularly, the inventors have developed a process, wherein the active agent is introduced in the plastic composition, by simply contacting the plastic composition with the active agent. To this end, a plastic material is foamed to create bubbles within the plastic material, and active agents are fixed on the surface and in the cell-structures of the resulting foamed plastic material Particularly, the walls of the foamed plastic composition and/or of the cell structures within the foamed plastic composition are at least partially coated with the active agent. In a particular embodiment, the active agent is at least partially included in the closed-cell structures and/or open-cell structures of the foamed plastic composition.

In a particular embodiment, the active agent of the foamed plastic composition has been deposited on the walls and/or cell structures of the foamed plastic material by immersion of the foamed plastic material in a cooling liquid comprising said active agent after the foaming step.

In an embodiment, the foamed plastic composition exhibits a porosity rate between 20% and 90%, preferably between 25% and 50%. Particularly, the porosity rate is between 30% and 40%. Alternatively, the plastic composition exhibits a porosity rate above 20%, preferably above 30%, more preferably above 40%. As used herein, the term “porosity rate” refers to the void fraction in a plastic composition or product, and corresponds to the ratio volume of voids (i.e. pores) within the plastic composition or product to total volume of said plastic composition or product.

The porosity rate can be estimated by any method known by a person skilled in the art. Preferably, the “porosity rate” (ET) of the plastic product is estimated using the following equation:

$${ε}_{⊤} = 1 - \frac{{ρ}_{app}^{water}}{{ρ}_{p}^{water}} with :$$

ρₐₚₚ^{water} is the apparent density of the foamed plastic product measured using water pycnometry.
ρₚ^{water} is the true density of the plastic product based on its composition or measured on the unfoamed plastic composition. Particularly the plastic composition is under pellet form.

Water pycnometry consists in measuring the mass of a specific volume of water and the mass of the same volume comprising water and the foamed plastic product for which density has to be determined. This allows the determination of apparent density of the sample, giving access to the porosity rate of the material, as far as the density of the original (i.e. unfoamed) plastic product is known (i.e. true density). As an example, the true density of a plastic product comprising 100% PET from literature is 1380 kg·m−3, corresponding to the density of PET. The water pycnometry method is particularly adapted for calculating the density of products with irregular shapes. In case of products with a regular shape (e.g. cylinders) it is possible to directly calculate the volume of the product and thus assessing its apparent density.

According to the invention, the term “active agents” refer to any substance or compound that may have an effect on another substance or compound when contacted with. Particularly, active agents refer to biological or chemical agents.

In a particular embodiment, the active agent is selected from biological entities having a degrading activity, particularly a polymer degrading activity. These biological entities encompass degrading enzymes and microorganisms producing degrading enzymes, such as bacteria, fungi and yeasts, including sporulating microorganisms and/or spores thereof.

In a preferred embodiment, the active agents comprise one or more enzymes having a polymer degrading-activity, more preferably a polyester-degrading activity. As used herein, the term “degrading enzyme” refers to an enzyme having a polymer degrading activity. In the context of the invention, “degrading enzyme” may refer to pure enzymes (i.e., in absence of any excipients, additives, etc.) or to formulations containing enzyme(s) and diluent(s) and/or carrier(s), such as stabilizing and/or solubilizing component(s), including water, glycerol, sorbitol, dextrin, (e.g., maltodextrin and/or cyclodextrin), starch, arabic gum, glycol (e.g., propanediol), salt, etc. The degrading enzyme may be in solid (e.g., powder) or liquid form.

Examples of suitable enzymes having a polymer-degrading activity include, without limitation, depolymerase, esterase, lipase, cutinase, hydrolase, protease, polyesterase, oxygenase and/or oxidase such as laccase, peroxidase, oxygenase, lipoxygenase, mono-oxygenase, or lignolytic enzyme, a carboxylesterase, a p-nitrobenzylesterase, a scl-PHA depolymerase, a mcl-PHA depolymerase, a PHB depolymerase, an amidase, aryl-acylamidase (EC 3.5.1.13), oligomer hydrolase, such as 6-aminohexanoate cyclic dimer hydrolase (EC 3.5.2.12), 6-aminohexanoate dimer hydrolase (EC 3.5.1.46) or 6-aminohexanoate-oligomer hydrolase (EC 3.5.1.B17).

In a particular embodiment, the active agent is a cutinase, preferably a cutinase produced by a microorganism selected from Thermobifida cellulosityca, Thermobifida halotolerans, Thermobifida fusca, Thermobifida alba, Bacillus subtilis, Fusarium solani pisi, Humicola insolens, Sirococcus conigenus, Pseudomonas mendocina and Thielavia terrestris, or any functional variant thereof. In another embodiment, the cutinase is selected from a metagenomic library such as LC-Cutinase described in Sulaiman et al., 2012 or the esterase described in EP3517608, or any functional variant thereof including depolymerases listed in WO 2018/011284 or WO 2018/011281. In another particular embodiment, the active agent is a lipase preferably produced by Ideonella sakaiensis. In another particular embodiment, the active agent is a cutinase produced by Humicola insolens, such as the one referenced A0A075B5G4 in Uniprot or any functional variant thereof. In another embodiment, the active agent is selected from commercial enzymes such as Novozym 51032 or any functional variant thereof.

In another particular embodiment, the active agent is a protease, preferably produced by a microorganism selected from Amycolatopsis sp., Amycolatopsis orientalis, Tritirachium album (proteinase K), Actinomadura keratinilytica, Laceyella sacchari LP175, Thermus sp. or any commercial enzymes known for degrading PLA such as Savinase®, Esperase®, Everlase® or any functional variant thereof including depolymerases listed in WO 2016/062695, WO 2018/109183 or WO 2019/122308.

In another particular embodiment, the active agent is an esterase, preferably a cutinase or a lipase more preferably selected from CLE from Cryptococcus sp., lipase PS from Burkholderia cepacia, Paenibacillus amylolyticus T1B-13, Candida Antarctica, Rhizomucor miehei, Saccharomonospora viridis, Cryptococcus magnus or any functional variant thereof.

In another particular embodiment, the active agent is an oxidase, preferably a rubber oxidase, selected from Lcp latex clearing protein from Streptomyces sp., RoxA rubber oxygenase A from Xanthomonas sp., RoxB rubber oxygenase B from Xanthomonas sp. or horseradish peroxidase or laccase with a redox mediator selected from hydroxybenzotriazole or ABTS.

In an embodiment, the biological entities are suitable to degrade the polymer of the foamed plastic composition. Alternatively, the biological entities are not suitable to degrade the polymer of the foamed plastic composition.

In another embodiment, the active agents are selected from drugs (i.e. substance that may have an impact on a living organism, including mammal, avian, virus, fungi and microorganisms). Notably, the term drug encompasses active substances, mineral or organic, that may have a prophylactic or therapeutic activity on a mammal, substances with antifungal and/or antimicrobial activity, etc. For instance, the drug is selected from pharmaceutical agent, Traditional Chinese Medicine, antibiotic, anti-cancer agent, anti-viral agent, anti-inflammatory agent, hormone, growth factor, etc., an antigen, a vaccine, an adjuvant, etc. The drug may also consist on a cosmetic agent.

In a particular embodiment, the drug is chosen among compounds having therapeutic or prophylactic purposes in a mammal, and more particularly in a human. In a particular embodiment, the drug is selected from chemicals, pharmaceutical compound, nutraceutical compound, amino acids, peptides, proteins, polysaccharides, lipid derivatives, antibiotics, analgesics, vaccines, vaccine adjuvants, anti-inflammatory agents, anti-tumor agents, hormones, cytokines, anti-fungal agents, anti-viral agents, anti-bacterial agents, anti-diabetics, steroids, vitamins, pro-vitamins, antioxidants, mineral salts, trace elements, specific enzyme inhibitor, growth stimulating agent, immunosuppressors, immuno-modulators, anti-hypertensive drugs, anti-arrhythmic drugs, inotropic drugs, addiction therapy drugs, anti-epileptic drugs, anti-aging drugs, drugs to treat neuropathies or pain, hypolipemic drugs, anti-coagulants, antibodies or antibody fragments, antigens, anti-depressant or psychotropic agents, neuro-modulators, drugs for treating a disease selected from brain disease, liver disease, pulmonary disease, cardiac disease, gastric disease, intestine disease, ovary disease, testis disease, urological disease, genital disease, bone disease, muscle disease, endometrial disease, pancreatic disease and/or renal disease, ophthalmic drugs, anti-allergic agents, contraceptive or luteinizing agents, enzymes, Traditional Chinese Medicines, nutrients, cosmetics and mixtures of at least two of these drugs.

In another embodiment, the active agents are selected from phytosanitary compounds such as pesticides, including fungicides and herbicides, insecticide, miticide, agent for exterminating rodents, insect repellents, fertilizers and biocontrol agents. Examples of phytosanitary compounds are cited in U.S. Pat. No. 9,420,780B2.

In another embodiment, the active agents are selected from perfumes and/or odorous molecules.

In a particular embodiment, the foamed plastic composition is a masterbatch that can be used for introducing the active agent in a polymer-based matrix. As used herein, the term “masterbatch composition” designates a concentrated mixture of selected ingredients (e.g., active agents, additives, etc.) that can be used for introducing a desired amount of said ingredients into plastic articles or materials in order to impart desired properties thereto. In the context of the invention, masterbatch compositions are under solid form. Such masterbatch preferably comprises between 11% and 90% by weight of active agent, based on the total weight of the foamed plastic composition, preferably between 11% and 60% wt of active agent, more preferably above 15%, even more preferably above 20% by weight of active agent. In another embodiment, the foamed masterbatch composition comprises between 0.1% and 10% by weight of active agent, based on the total weight of the foamed masterbatch composition, preferably between 0.5% and 8% wt of active agent, between 0.5% and 5% wt, between 1% and 10% wt, between 1% and 5% wt, between 2% and 10% wt, between 2% and 5% wt, of active agent. Alternatively, the foamed masterbatch composition comprises between 0.1% and 20% by weight of active agent, based on the total weight of the foamed masterbatch composition, preferably between 5% and 15% wt of active agent, more preferably between 5% and 10% wt of active agent.

In an embodiment, the foamed plastic composition is a polymer-based matrix that comprises between 11% and 90% by weight of active agent, based on the total weight of the foamed plastic composition, particularly between 40% and 60% wt. Alternatively, the foamed plastic composition comprises less than 10% wt, preferably between 0.1% and 10% by weight of active agent, based on the total weight of the foamed masterbatch composition, more preferably between 0.5% and 8% wt of active agent, between 0.5% and 5% wt, between 1% and 10% wt, between 1% and 5% wt, between 2% and 10% wt, between 2% and 5% wt, of active agent.

In another embodiment, the foamed plastic composition is a polymer-based matrix that comprises at most 10% wt of active agent, based on the total weight of the foamed plastic composition. Particularly, the polymer-based matrix comprises from 0.01 to 10% wt of active agent.

In a particular embodiment, the foamed plastic composition is a masterbatch that comprises at least 0.001% by weight of pure degrading enzyme, based on the total weight of the masterbatch composition. In a particular embodiment, the masterbatch composition comprises between 0.001 and 30 wt %, preferably between 0.1% and 20 wt %, more preferably between 0.1% and 10 wt % of pure degrading enzyme. In a particular embodiment, the masterbatch composition comprises about 1% by weight of pure degrading enzyme. Alternatively, the masterbatch composition comprises about 5% by weight of pure degrading enzyme.

According to the invention, the polymer of the plastic material is selected from polyolefins, aliphatic and semi-aromatic polyesters, polyamides, polyurethanes, vinyl polymers, polyethers, ester-ether copolymers or thermoplastic elastomers and derivatives thereof, preferably from aliphatic and semi-aromatic polyesters.

Preferred polyolefins for use in the present invention include, without limitation, polyethylene (PE), polypropylene (PP), polymethylpentene (PMP), polybutene-1 (PB-1), polyisobutylene (PIB), cyclic olefin copolymer (COC) and derivatives or blends/mixtures thereof.

Preferred aliphatic polyesters for use in the invention include, without limitation, polylactic acid (PLA), poly(L-lactic acid) (PLLA), poly(D-lactic acid) (PDLA), poly(D,L-lactic acid) (PDLLA), PLA stereocomplex (scPLA), polyglycolic acid (PGA), polyhydroxyalkanoate (PHA), polycaprolactone (PCL), polybutylene succinate (PBS); and semi-aromatic polyesters are selected from polyethylene terephthalate (PET), polytrimethylene terephthalate (PTT), polybutylene terephthalate (PBT), polyethylene isosorbide terephthalate (PEIT), polybutylene succinate adipate (PBSA), polybutylene adipate terephthalate (PBAT), polybutylene adipate (PBA), polyethylene furanoate (PEF), poly(ethylene adipate) (PEA), polyethylene naphthalate (PEN), and copolymers thereof such as poly(lactic-co-glycolic acid) copolymers (PLGA) and derivatives or blends/mixtures thereof. The polyethers may be selected e.g., from polyethylene glycol (PEG), preferably PEG with molecular mass above 600 g/mol, polyethylene oxide (PEO), or copolymers and blends/mixtures thereof. The ester-ether copolymers may be selected e.g., from polydioxanone (PDS).

Preferred polyamide polymers (also called nylon) for use in the invention include without limitation, polyamide-6 or poly(O-caprolactam) or polycaproamide (PA6), polyamide-6,6 or poly(hexamethylene adipamide) (PA6,6), poly(11-aminoundecanoamide) (PA11), polydodecanolactam (PA12), poly(tetramethylene adipamide) (PA4,6), poly(pentamethylene sebacamide) (PA5,10), poly(hexamethylene azelaamide) (PA6,9), poly(hexamethylene sebacamide) (PA6,10), poly(hexamethylene dodecanoamide) (PA6,12), poly(m-xylylene adipamide) (PAMXD6), polyhexamethylene adipamide/polyhexamethyleneterephthalamide copolymer (PA66/6T), polyhexamethylene adipamide/polyhexamethyleneisophthalamide copolymer (PA66/6I) and derivatives or blends/mixtures thereof.

Preferred vinyl polymers include polystyrene (PS), polyvinyl chloride (PVC), polyvinyl chloride (PVdC, ethylene vinyl acetate (EVA), ethylene vinyl alcohol (EVOH), polyvinyl alcohol (PVOH) and derivatives or blends/mixtures of these materials. In a particular embodiment, the polymer of the plastic composition has a melting temperature below 180° C. and/or a glass transition temperature below 70° C., preferably selected from the group consisting in PLA, PCL, PBS, PBSA, PBAT, PHA, EVA, more preferably selected from PLA, PCL, PBS, PBSA or PBAT. In an embodiment, the foamed plastic composition further comprises fillers and/or additives such as plasticizers.

In an embodiment, the polymer in the foamed plastic composition exhibits a degree of crystallinity of at most 30%, preferably at most 25%, more preferably at most 20%, even more preferably at most 15%. In a particular embodiment, said polymer in the foamed plastic composition is PET.

In another embodiment, the polymer in the foamed plastic composition exhibits a degree of crystallinity of at most 50%, preferably at most 30%, more preferably at most 25%, even more preferably at most 20%. In a particular embodiment, said polymer in the foamed plastic composition is PLA.

In a particular embodiment, the foamed composition comprises at least one polyester, preferably selected from PCL, PBAT, PBSA, PBS, PBA, PGA, PLA, PLGA and PHA, more preferably PCL and PLA, and an active agent selected from biological entities having a degrading activity, particularly a polymer degrading activity. Preferably the biological entities are suitable to degrade PLA. Preferably the biological entities are selected from enzymes having a PLA degrading activity, particularly a protease. Alternatively, the biological entities are suitable to degrade PET. Preferably the biological entities are selected from enzymes having a PET degrading activity, particularly an enzyme selected from a cutinase and/or a lipase.

In a particular embodiment, the foamed composition is a masterbatch and the masterbatch composition comprises, based on the total weight of the masterbatch composition (i) from 70 to 99.9 wt % of at least one polyester, preferably selected from PCL, PBAT, PBSA, PBS, PBA, PGA, PLA, PLGA and PHA, more preferably PCL and PLA, and (ii) from 0.1 to 30 wt % of degrading enzyme particularly from 0.1 to 20% wt of pure degrading enzyme. More preferably, the masterbatch composition comprises (i) from 80 to 99.9 wt % of at least one polyester, preferably selected from PCL, PBAT, PBSA, PBS, PBA, PGA, PLA, PLGA and PHA, more preferably PCL and PLA and (ii) from 0.1 to 20 wt % of degrading enzyme, particularly from 0.1 to 10 wt % of pure degrading enzyme.

Particularly, the degrading enzyme is selected from proteases.

Alternatively, the degrading enzyme is selected from cutinase and/or lipase having a PET-degrading activity.

In an embodiment, the foamed composition is a masterbatch and the masterbatch composition comprises, based on the total weight of the masterbatch composition (i) from 70 to 99.9 wt % of PLA and (ii) from 0.1 to 30 wt % of protease, more preferably from 0.1 to 20 wt % of pure protease.

In another embodiment, the foamed composition is a masterbatch and the masterbatch composition comprises, based on the total weight of the masterbatch composition (i) from 70 to 99.9 wt % of PCL and (ii) from 0.1 to 30 wt % of PET-degrading enzymes, particularly selected from cutinase and/or lipase, more preferably from 0.1 to 20 wt % of pure cutinase and/or lipase.

Process for Producing the Foamed Plastic Composition

It is also another object of the invention to provide a process for producing a foamed plastic composition comprising at least one polymer and at least one active agent, wherein said foamed plastic composition is at least partially coated with the active agent, particularly within the cell-structure of the foamed composition.

In an embodiment, the invention provides a process for incorporating an active agent in a foamed plastic composition, wherein the process comprises the steps of:
a. Foaming a plastic material comprising at least one polymer; and subsequently
b. Cooling the foamed plastic material by contacting said foamed plastic material with a cooling liquid comprising said active agent

Advantageously, the foamed plastic composition is submitted to a granulation step after step (b).

In an embodiment, the foaming step is performed at a temperature at which the plastic material is in partially or totally molten state. Particularly, the foaming step is performed at a temperature above the crystallization temperature (Tc) of at least one polymer of the plastic material. Preferably, the plastic material is submitted to a temperature at or above the melting temperature (Tm) of said polymer. Even more preferably, the plastic material is submitted to a temperature between Tm+5° C. and Tm+25° C. of said polymer, preferably between Tm+10° C. and Tm+25° C., more preferably between Tm+15° C. and Tm+25° C., such as Tm+20° C. of said polymer. In another embodiment, the plastic material is submitted to a temperature between Tm+25° C. and Tm+50° C. of said polymer. In another embodiment, the plastic material is submitted to a temperature corresponding to the Tm+50° C. of said polymer or above.

According to an embodiment of the invention, the plastic material comprises several different polymers. Particularly, the plastic material comprises at least 51% by weight of a target polymer. In such case, the plastic material is advantageously submitted to a temperature at or above the Tc or to a temperature at or above the Tm of said target polymer. Alternatively, the plastic material is submitted to a temperature at or above the highest Tc or Tm of the polymers contained in the plastic product.

In a particular embodiment, the plastic material comprises PET, and the foaming step comprises submitting the plastic material to a temperature above 170° C., preferably at or above 230° C. and more preferably to a temperature between 250° C. and 300° C. Even more preferably, the plastic material comprising PET is submitted to a temperature between 260° C. and 280° C. In another embodiment, the plastic material comprising PET is submitted to a temperature at or above 300° C., preferably between 300° C. and 320° C.

In another particular embodiment, the plastic material comprises PLA, and the foaming step comprises submitting the plastic material to a temperature above 110° C. and more preferably at or above 145° C. In a particular embodiment, the plastic material comprises PLLA, and the foaming step comprises submitting the plastic material to a temperature at or above 170° C. In another embodiment, the plastic material comprises stereocomplex PLA and the foaming step comprises submitting the plastic product to a temperature at or above 230° C.

As used herein, the “foaming step” refers to a step by which cells (also called bubbles) are created in the structure of the plastic material by use of foaming agents, also called blowing agents. Gas generated by said foaming agents creates bubbles within the molten or the partially molten plastic material, forming closed-cells and/or opened-cells in the plastic material. The resulting foamed plastic material exhibits a cellular structure, which has a lower density than the plastic material density before the foaming step.

Foaming agents can be classified as “physical foaming agents” or “chemical foaming agents”, depending on how the bubbles are generated. According to the invention, the foaming step is implemented by use of one or more foaming agents selected from physical foaming agents, chemical foaming agents and mixture thereof. In a particular embodiment, the foaming step is implemented by use of physical foaming agent(s). Alternatively, the foaming step is implemented by use of chemical foaming agent(s). In another embodiment, the foaming step is implemented by use of both physical foaming agent(s) and chemical foaming agent(s).

In the context of the invention, “physical foaming agents” refer to compounds that undergo a physical change of state during processing. Physical foaming agents include pressurized gases (such as nitrogen, carbon dioxide, methane, helium, neon, argon, xenon and hydrogen or mixed thereof) which expand when returning to atmospheric pressure during the process of foaming, and low-boiling-point liquids (such as pentane, isopentane, hexane, methylene dichloride, and dichlorotetra-fluoroethane) which expand when heated by changing from a liquid to a gaseous state and thereby produce a higher volume of vapor.

In a particular embodiment, the physical foaming agent is a gas. Preferably, the physical foaming agent is selected from the group consisting of nitrogen, carbon dioxide, argon, helium, methane, neon, argon, xenon, hydrogen or mixed thereof. More preferably, the physical foaming agent is selected from carbon dioxide and nitrogen. In another embodiment, the physical foaming agent is selected from the group consisting of saturated aliphatic hydrocarbons, such as methane, ethane, propane, butane, pentane and hexane; saturated alicyclic hydrocarbons, such as cyclopentane, cyclohexane, ethylcyclopentane, aromatic hydrocarbons, such as benzene, toluene, xylene; halogenated saturated hydrocarbons, such as methylene chloride, carbon tetrachloride; ethers, such as methylal, acethal, 1,4-dioxane and ketones, such as acetone, methyl ethyl ketone and acetyl ketone or a mix thereof. Alternatively, the physical foaming agent is selected from low-boiling-point liquids, selected from the group consisting of pentane, isopentane, hexane, methylene dichloride, and dichlorotetra-fluoroethane. Particularly, the low-boiling-point liquid has a boiling temperature below the temperature at which the plastic product is in partially or totally molten state. In an embodiment, the step of foaming can be implemented using one or several of the physical foaming agents listed above. In a particular embodiment, the polymer of the plastic article submitted to a foaming step with a physical foaming agent has an intrinsic viscosity index above 0.5, preferably above 0.6.

In a particular embodiment, the physical foaming agent is injected in the partially or totally molten plastic material. In other words, the plastic material is first heated and when it is molten the physical foaming agent is injected within the molten material.

In the context of the invention, “chemical foaming agents” refer to foaming agents that undergo a decomposition reaction during polymer heating at a given temperature, leading to the release of gas, such as nitrogen, carbon dioxide, carbon monoxide, nitroxide, NOx compounds, ammonia and/or vapor of water. Such chemical foaming agents can be selected from the group consisting of azides, hydrazides such as p,p′-hydroxybis-(benzenesulfonyl hydrazide), semicarbazides, such as p-toluenesulfonyl semicarbazide, p-toluenesulfonyl semicarbazide, azocompounds such as azodicarboxamide, triazoles, such as nitrotriazolone, tetrazoles, such as 5-phenyltetrazole, bicarbonates, such as zinc bicarbonate or alkali bicarbonates such as sodium bicarbonate, anhydride, peroxide, nitrocompounds, perchlorates. Alternatively, the chemical foaming agents are selected from citric acid, carbonate, bicarbonate and mixture thereof, or any commercial chemical foaming agent such as HYDROCEROL® from Clariant, or Orgater® from Adeka. Preferably, the chemical foaming agents comprise a mix of citric acid and carbonate and/or a mix of citric acid and bicarbonate. Alternatively, the chemical foaming agent comprises hydrogen peroxide. In an embodiment, the step of foaming can be implemented using one or several of the chemical foaming agents listed above.

In a particular embodiment, the step of foaming comprises a step of mixing the chemical foaming agent(s) with the plastic material at ambient temperature and then submitting the mixture to a temperature at which the plastic material is in a partially or totally molten state. In another embodiment, the chemical foaming agent is added to the at least partially molten plastic material. In other words, the plastic material is first heated and when it is molten the chemical foaming agent is mixed within the molten material.

In an embodiment, the foaming step is implemented with both chemical foaming agent(s) and physical foaming agent(s).

In an embodiment, the process of the invention comprises contacting from 0.1 to 10%, preferably from 0.1 to 5%, by weight of foaming agent(s) with 90% to 99.9%, preferably with 95% to 99.9%, by weight of plastic product based on the total weight of the mix foaming agents/plastic product. Particularly, the process of the invention comprises contacting from 0.1 to 10% by weight of chemical foaming agent with 90% to 99.9% by weight of plastic product based on the total weight of the mix foaming agents/plastic product. Preferably, the process of the invention comprises contacting from 1 to 5% by weight of chemical foaming agent with 95% to 99% by weight of plastic product. Alternatively, the process of the invention comprises contacting from 0.1 to 5%, preferably from 0.1 to 3%, more preferably from 0.1% to 1%, by weight of chemical foaming agent with 95% to 99.9%, preferably with 97% to 99.9%, more preferably with 99% to 99.9%, by weight of plastic product. In another embodiment, the process of the invention comprises contacting from 0.1 to 5% by weight of physical foaming agent with 95% to 99.9% by weight of plastic product based on the total weight of the mix foaming agents/plastic product. Preferably, the process of the invention comprises contacting from 0.1 to 3.5% by weight of physical foaming agent with 96.5% to 99.9% by weight of plastic product.

In an embodiment, the foaming step is implemented with foaming agent(s) and a processing aid, such as waxes, nucleation agents, chain extenders, foaming kickers or water. Particularly, the foaming step is implemented with foaming agent(s) and from 0.01 to 10%, preferably 0.01 to 1% by weight of processing aid, based on the total weight of the mix foaming agents/plastic product/processing aids.

In an embodiment, the foaming step is performed with an extruder, wherein the plastic material is submitted to a temperature at which the plastic material is in a partially or totally molten state. The foaming agent may be introduced in the extruder before heating, during heating, and/or when the material has been heated and is already in a molten state. Alternatively, the foaming step may be carried out by any techniques known by a person skilled in the art.

According to the invention, the process further comprises a step of cooling the at least partially foamed plastic material, by contacting said foamed plastic material with a cooling liquid comprising said active agent. Particularly, the at least partially foamed plastic material is immersed in the cooling liquid subsequently to the foaming step. Preferably, the cooling step occurs immediately after the foaming step. For instance, when the foaming step is performed in an extruder, the cooling step is performed on extruded foamed plastic material coming out of the extruder. In a particular embodiment, the foamed material coming out the extruder is received in a cooling liquid comprising the active agent.

Generally speaking, the inventors have discovered that when the foamed material is contacted with the active agent during its cooling, the active agent may be incorporated within the cell-structures, including the closed-cell structures, that form during the cooling. A rapid cooling step (i.e. rapidly after the foaming) allows to trap and fix the active agent within the cell-structures quite simultaneously to their formation. It is thus of particular interest to proceed to the cooling step less than 30 seconds after the extrusion of the foamed material from the extruder wherein the polymers have been contacted with the foaming agents, preferably less than 20 seconds, more preferably less than 10 seconds. Particularly, the plastic material is submitted to the cooling step immediately after the end of the foaming (i.e. heating) step.

Generally speaking, the plastic material is subjected to the cooling temperature for a period of time sufficient to decrease the temperature at the very heart of the plastic material. For instance, such period of time may be comprised between 1 second and several minutes, depending on the initial temperature of the foamed plastic material (i.e. before the cooling step), and/or the cooling temperature and/or the nature/form of the plastic material and the throughput of the plastic material. In an embodiment, the plastic material is under a pellet form with a size below 1 cm and is submitted to the cooling temperature for less than 1 minute, preferably less than 30 seconds, more preferably less than 20 seconds, even more preferably less than 10 seconds. Alternatively, the foamed plastic material going out of the extruder is shaped into tube or sheet.

In a particular embodiment, the cooling liquid comprises at least water and the active agent. In a preferred embodiment, the active agent is selected from biological entities having a degrading activity, preferably from degrading enzymes and microorganisms producing degrading enzymes. The cooling liquid may further comprise a diluent or carrier, acting as stabilizing and/or solubilizing component(s) for the active agents. For instance, the cooling liquid may be a solution comprising enzymes and/or microorganisms and/or cells in suspension in water, and optionally additional components, such as glycerol, sorbitol, dextrin, starch, glycol such as propanediol, salt, etc. In an embodiment, the active agent is soluble in the cooling liquid at the temperature of said liquid. As an example, the cooling may be performed by immersing the plastic material into a liquid at the cooling temperature, subsequently to the foaming step. For instance, the at least partially foamed plastic material is immersed into a liquid at room temperature, more preferably at a temperature below room temperature at the end of the foaming step. For instance, the plastic article is immersed in a cold liquid, whose temperature is below 14° C., preferably below 10° C. or below 5° C. In a particular embodiment, the plastic product is immersed into cold water, such as water at or below 5° C. More generally, any method suitable for rapidly reducing the temperature of the plastic product may be used (e.g. cold air).

In a preferred embodiment, the foaming step is performed in an extruder. The extruder allows to submit the plastic material both to a given temperature and to shear stress, simultaneously or sequentially. Advantageously, the foamed plastic material that comes out of the extruder is directly cooled by immersion and/or by pulverization of water. Advantageously, the extruder is selected from single-screw extruders, multi-screw extruders of either co-rotating or counter-rotating design, planetary roller extruder, dispersive kneaders, reciprocating single-screw extruder (co-kneaders), mini extruder or internal mixer.

In an embodiment, an underwater pelletizer or an underwater strand pelletizer, allowing to cut plastic material directly in cold water, is fixed to the head of the extruder leading to the production of plastic pellets immediately submitted to the cooling phase. In such embodiment, the plastic product is under pellet form with a size below lcm, preferably between 0.5 and 5 mm and is submitted to the cooling temperature for less than 1 minute, preferably less than 30 seconds, more preferably less than 20 seconds, even more preferably less than 10 seconds. Particularly, a microgranulation underwater pelletizer producing mini pellets under 1 mm is fixed to the head of the extruder.

In an embodiment, the cooling liquid comprises a concentration of active agent preferably selected from degrading enzymes above 0.1 g/L, preferably above 1 g/L, 2 g/L, 3 g/L, 4 g/L, 5 g/L, 6 g/L, 7 g/L, 8 g/L, 9 g/L, 10 g/L. In an embodiment, the cooling liquid comprises a concentration of active agent below 100 g/L, preferably below 50 g/L. In an embodiment, the cooling liquid comprises a concentration of degrading enzymes from 0.1 to 30 g/L, preferably from 5 to 25 g/L.

In a particular embodiment, the cooling step comprises submitting the foamed plastic material comprising at least one polymer to a liquid at a temperature below the Tc of said polymer, preferably below the glass temperature (Tg) of said polymer. For instance, the at least partially foamed plastic material is immersed into a liquid at room temperature, more preferably at a temperature below room temperature at the end of the foaming step. For instance, the plastic material is immersed in a cold liquid, whose temperature is below 14° C., preferably below 10° C. or below 5° C. In a particular embodiment, the plastic material is immersed into cold water, such as water at or below 5° C. Alternatively, the plastic material is immersed in a liquid, whose temperature is below the Tc of the target polymer.

Such fast cooling after a heating phase further allows to obtain at least one amorphized polymer of said plastic product. The amorphization takes place during the foaming step (i.e. the heating step) by allowing to break at least partially the crystalline structure of polymer of the plastic product, and the fast cooling step allow to fix said heated polymer in amorphous state. Amorphization of a polymer can thus be performed during the foaming step by submitting the plastic material to a temperature above the Tc, preferably above the Tm of said polymer and rapidly cooling the plastic material at a temperature below the Tc and/or the Tg of said polymer.

As used herein, the terms “amorphization” and “amorphizing”, in connection with a polymer refer to a decrease of the degree of crystallinity of a given polymer compared to its degree of crystallinity before amorphization. Preferably, amorphization allows to decrease the crystallinity of a target polymer of at least 5%, 10%, 15%, 20%, 25%, 30%, 35%, 40%, 50%, 60%, 70%, 80%, or 90% compared to its degree of crystallinity before amorphization. Advantageously, the amorphization leads to polymer with at most 30% of crystallinity, preferably at most 25%, more preferably at most 20%, even more preferably at most 15% of crystallinity. Alternatively, amorphization allows to maintain the crystallinity of a polymer below 30%, preferably below 25%, more preferably below 20%, even more preferably below 15%. Amorphization may be performed by any process known by the person skilled in the art to break at least partially the crystalline structure of a polymer and particularly any process described in WO 2017/198786.

In an embodiment, the foamed plastic composition is a masterbatch and is not submitted to an amorphization step.

The temperatures of foaming and cooling can be adapted by a person skilled in the art depending on the target polymer. Similarly, a person skilled in the art know when and/or how to perform degassing during the foaming step, before and/or after the introduction of the foaming agent. Generally speaking, the plastic material can be submitted to a heat treatment and optionally shear stress for a period of time sufficient to obtain amorphization of the target polymer. For instance, such period of time may be comprised between 10 seconds and several minutes, depending on the temperature of the plastic material and/or the shape and dimensions of the plastic material. In a preferred embodiment, the foaming step comprises submitting the plastic material to both shear stress and a temperature above the Tc of the target polymer of the plastic material, preferably at or above the Tm of said polymer. The heating and submission to shear stress are preferably performed simultaneously to increase amorphization during the foaming step.

In a particular embodiment, the cooling is performed by submitting the heated and foamed plastic material to a cooling temperature corresponding to a temperature below the Tc of the target polymer of the plastic material, preferably below the Tg of said polymer. The submission to a temperature below the Tc of the target polymer of the plastic material is particularly adapted to PBAT for instance or to any polymer whose Tg is below 20° C. In another embodiment, the cooling is performed by submitting the heated and foamed plastic material to a temperature at least 20° C. below the Tc of the target polymer, preferably less than at least 30° C., 40° C., 50° C. In an embodiment, the cooling is performed by submitting the plastic material to room temperature (i.e. 25° C.+/−5° C.). In another embodiment, the cooling is performed by submitting the plastic material to a temperature of about 20° C., or about 10° C.

Advantageously, the foamed plastic composition is submitted to a granulation step after the cooling step in order to obtain pellets.

In an embodiment, following the cooling step, the foamed plastic composition is further submitted to a drying step or a water vacuum step. Particularly, the foamed plastic composition is placed in an oven at a temperature above 30° C., preferably above 40° C. More preferably, the drying temperature is below 80° C.

The process for incorporating an active agent in a foamed plastic composition of the invention may be carried out by any techniques known by a person skilled in the art that enable a foaming step, a cooling step with a liquid comprising the active agent and optionally a granulation step to obtain pellets.

Plastic Articles

The process of the present invention is particularly useful for producing plastic compositions integrating heat sensitive active agents, such like enzymes, hormones, cells, microorganisms, etc. Indeed, the active agent is introduced in the plastic composition after the heating phase and is thus not submitted to elevated temperatures or at least only for short time. The plastic composition can thus be used for manufacturing plastic articles that integrate the active agent. Particularly, the foamed plastic composition of the present invention can be used for manufacturing biodegradable plastic articles, wherein polymer-degrading enzymes are incorporated. The foamed plastic composition of the present invention can also be used for manufacturing medical devices integrating drugs.

The invention also relates to the use of such plastic compositions for manufacturing plastic articles. It is also an object of the invention to provide a plastic article made with the plastic composition of the invention. Therefore, the invention relates to a method for manufacturing a plastic article comprising at least one polymer, the method comprising:
A. providing a foamed plastic composition of the invention; and
B. shaping said plastic composition into a plastic article.

Advantageously, step B is implemented at a temperature at which the polymer of the plastic composition is in a partially or totally molten state. For instance, step B may be performed at a temperature at or above 40° C., particularly at or above 45° C., 55° C., 60° C., 70° C., 80° C., 90° C., 100° C., or even above 150° C., depending on the nature of the polymer(s) of the plastic composition. Typically, this temperature does not exceed 300° C. More particularly, the temperature does not exceed 250° C. The temperature of step B can be adapted by a person skilled in the art depending on the type of plastic composition and/or the kind of plastic articles intended. Particularly, the temperature is chosen according to the melting point, or melting temperature of the polymer of the plastic composition.

In a particular embodiment, step B is performed at the melting point of the polymer. The polymer is then in a partially or totally molten state. In another embodiment, step B is performed at a temperature between the glass transition temperature (Tg) and the melting point of said polymer. In another particular embodiment, step B is performed at a temperature above the melting point of said polymer.

Typically, said step B may be carried out by extrusion, extrusion-compounding, extrusion blow-molding, blown film extrusion, cast film extrusion, calendering and thermoforming, injection-molding, compression molding, extrusion-swelling, rotary molding, ironing, coating, stratification, expansion, pultrusion, compression-granulation, or 3D printing. Such operations are well known by the person skilled in the art, who will easily adapt the process conditions (e.g., temperature, residence time, etc.).

In a particular embodiment, step B is implemented with a solid plastic composition under powder or granulated form, preferably under a granulated form (e.g. pellets).

It is also an object of the invention to provide a plastic article made from the masterbatch composition of the invention. The invention relates to a method for manufacturing a plastic article comprising at least one polymer, the method comprising:
A. providing a masterbatch composition of the invention, and
B. mixing said masterbatch composition with a plastic material comprising at least one polymer, different or similar to the polymer of the masterbatch and shaping said mixture of plastic composition and masterbatch into a plastic article.

In a particular embodiment, step B is performed at the melting point of said polymer. The polymer is then in a partially or totally molten state. In another embodiment, step B is performed at a temperature above the glass transition temperature (Tg) and/or between the glass transition temperature (Tg) and the melting point (Tm) of said polymer. In another particular embodiment, step B is performed at a temperature above the melting point of said polymer. Typically, said step B may be carried out by extrusion, extrusion-compounding, extrusion blow-molding, cast film extrusion, calendering and thermoforming, injection-molding, compression molding, extrusion-swelling, rotary molding, ironing, coating, stratification, expansion, pultrusion, compression-granulation, or 3D printing. Such operations are well known by the person skilled in the art, who will easily adapt the process conditions (e.g., temperature, residence time, etc.). Particular embodiments related to the mixing of the masterbatch composition of the invention with a plastic material comprising at least one polymer can be found in WO 2016/198650 and/or WO 2019/020678.

Particularly, the step B is performed by mixing between 0.1 and 20% by weight of the masterbatch composition of the invention with 80% to 99.9% by weight of a plastic material, based on the total weight of the mix. Preferably, the step B comprises mixing from 0.1 to 15% by weight of the masterbatch composition of the invention with 85% to 99.9% by weight of a plastic material, more preferably from 0.1 to 10% by weight of the masterbatch composition with 90% to 99.9% by weight of a plastic material.

The foamed plastic composition of the invention is particularly suited for manufacturing plastic articles with improved and/or controlled degradability.

It is also an object of the invention to provide a plastic article made with the plastic composition of the invention, wherein the biological entities of the plastic composition are selected among biological entities suitable for degrading at least one polymer of the plastic article. Therefore, the invention relates to a method for manufacturing a plastic article comprising at least one polymer, the method comprising:
A. providing a foamed plastic composition of the invention comprising at least said polymer and an active agent selected from a biological entity, enzyme or microorganism, able to degrade said polymer; and
B. shaping said plastic composition into a plastic article.

The degradability of the resulting plastic article is increased as compared to a plastic article deprived of such degrading agent.

In a particular embodiment, the polymer of said resulting plastic article has been previously amorphized in order to increase the degradation ability.

Alternatively, it is also an object of the invention to provide a plastic article made with the masterbatch composition of the invention comprising biological entities and wherein the biological entities of the plastic composition are selected from biological entities suitable for degrading at least one polymer of the plastic article. The invention further relates to a method for manufacturing a plastic article comprising at least one polymer, the method comprising:
A. providing a masterbatch composition of the invention comprising at least one polymer and an active agent selected from biological entities, enzymes and microorganisms, and
B. mixing said masterbatch composition with a plastic material comprising at least one polymer, different or similar to the polymer of the masterbatch and shaping said mixture of plastic composition and masterbatch into a plastic article, wherein the biological entities of the masterbatch composition are selected from biological entities suitable for degrading at least said polymer of the plastic material.

The invention further relates to a method for manufacturing a multicomponent plastic article comprising at least one polymer, the method comprising:
A. providing a plastic material comprising at least one polymer
B. providing a masterbatch composition of the invention comprising at least one polymer and an active agent selected from biological entities, enzymes and microorganisms, able to degrade the polymer of the plastic material
C. shaping said multicomponent plastic article using a co-extrusion, coinjection and/or extrusion coating process, preferably a coextrusion process.

Such processes are described in WO 2020/193781.

In an embodiment, the polymer of the plastic material is different from the polymer of the masterbatch composition, and the masterbatch composition comprises biological entities that are unable to degrade the polymer of the masterbatch composition.

Advantageously, the resulting plastic article is a biodegradable plastic article complying with at least one of the relevant standards and/or labels known by a person skilled in the art such as standard EN 13432, standard ASTM D6400, OK Biodegradation Soil (Label Vinçotte), OK Biodegradation Water (Label Vinçotte), OK Compost (Label Vinçotte), OK Compost Home (Label Vinçotte).

A biodegradable plastic article refers to a plastic that is at least partially transformed under environmental conditions into oligomers and/or monomers and/or degradation products of at least one polymer of the plastic article, water, carbon dioxide or methane and biomass. For instance, the plastic article is biodegradable in water. Preferably, about 90% by weight of the plastic article is biodegraded in water within less than 90 days, more preferably within less than 60 days, even more preferably within less than 30 days. More preferably, the plastic article may be biodegraded when exposed to wet and temperature conditions that occur in landscape. Preferably, about 90% by weight of the plastic article is biodegraded with less than 3 years in the environment, more preferably within less than 2 years, even more preferably within less than 1 year. Alternatively, the plastic article may be biodegraded under industrial composting conditions, wherein the temperature is maintained above 50° C.

In a particular embodiment, the plastic article is made with a foamed plastic composition comprising PET and an active agent selected from esterases and microorganisms expressing esterases. Particularly, the active agent is selected from a cutinase produced by a microorganism selected from Thermobifida cellulosityca, Thermobifida halotolerans, Thermobifida fusca, Thermobifida alba, Bacillus subtilis, Fusarium solani pisi, Humicola insolens, Sirococcus conigenus, Pseudomonas mendocina and Thielavia terrestris, or any functional variant thereof. In another embodiment, the cutinase is selected from a metagenomic library such as LC-Cutinase described in Sulaiman et al., 2012 or the esterase described in EP3517608, or any functional variant thereof including depolymerases listed in WO 2018/011284 or WO 2018/011281. In another particular embodiment, the active agent is a lipase preferably produced by Ideonella sakaiensis. In another particular embodiment, the active agent is a cutinase produced by Humicola insolens, such as the one referenced A0A075B5G4 in Uniprot or any functional variant thereof. In another embodiment, the active agent is selected from commercial enzymes such as Novozym 51032 or any functional variant thereof.

In a particular embodiment, the plastic article is made with a foamed plastic composition comprising PLLA, and active agent selected from proteases and microorganisms expressing proteases. Particularly, the active agent is selected from proteases produced by a microorganism selected from Amycolatopsis sp., Amycolatopsis orientalis, Tritirachium album (proteinase K), Actinomadura keratinilytica, Laceyella sacchari LP175, Thermus sp. or any commercial enzymes known for degrading PLA such as Savinase®, Esperase®, Everlase® or any functional variant thereof including depolymerases listed in WO 2016/062695, WO 2018/109183 or WO 2019/122308.

In another particular embodiment, the plastic article is made with a foamed plastic composition comprising PDLA, and active agent selected from esterases and microorganisms expressing an esterase. The esterase is preferably a cutinase or a lipase, more preferably selected from CLE from Cryptococcus sp., lipase PS from Burkholderia cepacia, Paenibacillus amylolyticus TB-13, Candida Antarctica, Rhiromucor miehei, Saccharomonospora viridis, Cryptococcus magnus or any functional variant thereof.

In another particular embodiment, the plastic article is made with a foamed plastic composition comprising PA and an active agent selected from the group consisting of amidase, aryl-acylamidase (EC 3.5.1.13), oligomer hydrolase, such as 6-aminohexanoate cyclic dimer hydrolase (EC 3.5.2.12), 6-aminohexanoate dimer hydrolase (EC 3.5.1.46), 6-aminohexanoate-oligomer hydrolase (EC 3.5.1.B17) or microorganisms expressing said enzymes.

In another particular embodiment, the plastic article is made with a foamed plastic composition comprising polyolefin and active agent selected from oxidases, preferably selected from the group consisting of laccase, peroxidase, oxygenase, lipoxygenase, mono-oxygenase or lignolytic enzyme, or microorganisms expressing said enzymes.

In another embodiment, the active agent is a microorganism that expresses and excretes the enzyme. Said microorganism may naturally synthesize the depolymerase, or it may be a recombinant microorganism, wherein a recombinant nucleotide sequence encoding the depolymerase has been inserted, using for example a vector.

According to the invention, several microorganisms and/or purified enzymes and/or synthetic enzymes may be used together to depolymerize different kinds of polymers contained in the plastic composition.

The invention also provides a method for increasing the biodegradability of a plastic article comprising at least one polymer, wherein the method comprises the step of foaming a plastic material comprising at least said polymer and cooling said at least partially foamed plastic material in a liquid comprising an active agent selected from a biological entity, enzyme or microorganism, having the capacity to degrade said polymer, and the step of manufacturing a plastic article with said plastic composition.

It is also an object of the invention to provide a foamed masterbatch composition comprising at least one polymer, and at least one active agent selected from enzyme and microorganism able to degrade a polymer, wherein said foamed masterbatch composition is at least partially coated with the active agent. The invention also relates to the use of said masterbatch composition of the invention for manufacturing plastic articles with improved degradability or a controlled degradability. The masterbatch composition of the invention may be easily used to supply biological entities that have a polymer-degrading activity during the manufacturing process. According to the invention, the biological entities are selected among the biological entities able to degrade at least one polymer of the intended plastic article. Particular embodiments of masterbatch composition can be found in WO 2016/198650.

In a particular embodiment, the foamed masterbatch composition comprises at least one polyester, preferably selected from PCL, PBAT, PBSA, PBS, PBA, PGA, PLA, PLGA and PHA, more preferably PCL and PLA, more preferably from PLA, PCL, PBS, PBSA or PBAT, even more preferably PCL and an active agent selected from biological entities suitable to degrade PET, preferably an esterase, more preferably selected from cutinase or lipase. Advantageously, said masterbatch is further mixed with a polymer-based matrix of PET, and the resulting plastic composition can be used for manufacturing biodegradable plastic articles.

In a particular embodiment, the foamed masterbatch composition comprises at least one polyester, preferably selected from PCL, PBAT, PBSA, PBS, PBA, PGA, PLA, PLGA and PHA, more preferably PCL and PLA, more preferably from PLA, PCL, PBS, PBSA or PBAT and an active agent selected from biological entities suitable to degrade PLA, preferably a protease. Advantageously, said masterbatch is further mixed with a polymer-based matrix of PLA, and the resulting plastic composition can be used for manufacturing biodegradable plastic articles.

In another embodiment, the active agent comprises at least one drug and the foamed plastic composition integrating said active agent is used for manufacturing a medical device. Preferably, for this embodiment, the plastic composition comprises biocompatible polymer(s). Advantageously, at least one polymer selected from polyesters, polyethers or ester-ether copolymers. The polyester may be selected e.g., from polylactic acid (PLA), poly(L-lactic acid) (PLLA), poly(D-lactic acid) (PDLA), poly(D,L-lactic acid) (PDLLA), stereocomplex PLA (scPLA), polyhydroxy alkanoate (PHA), Poly(3-hydroxybutyrate) (P(3HB)/PHB), Poly(3-hydroxyvalerate) (P(3HV)/PHV), Poly(3-hydroxyhexanoate) (P(3HHx)), Poly(3-hydroxyoctanoate) (P(3HO)), Poly(3-hydroxydecanoate) (P(3HD)), Poly(3-hydroxybutyrate-co-3-hydroxyvalerate) (P(3HB-co-3HV)/PHBV), Poly(3-hydroxybutyrate-co-3-hydroxyhexanoate) (P(3HB-co-3HHx)/(PHBHHx)), Poly(3-hydroxybutyrate-co-5-hydroxyvalerate) (PHB5HV), Poly(3-hydroxybutyrate-co-3-hydroxypropionate) (PHB33HP), Polyhydroxybutyrate-co-hydroxyoctonoate (PHBO), polyhydroxybutyrate-co-hydroxyoctadecanoate (PHBOd), Poly(3-hydroxybutyrate-co-3-hydroxyvalerate-co-4-hydroxybutyrate) (P(3HB-co-3HV-co-4HB)), polyglycolic acid (PGA), polybutylene succinate (PBS), polybutylene succinate adipate (PBSA), polybutylene adipate terephthalate (PBAT), polycaprolactone (PCL), poly(ethylene adipate) (PEA) or copolymers thereof such as poly(lactic-co-glycolic acid) copolymers (PLGA) and blends/mixtures of these materials. The polyethers may be selected e.g., from polyethylene glycol (PEG), preferably PEG with molecular mass above 600 g/mol, polyethylene oxide (PEO), or copolymers and blends/mixtures thereof. The ester-ether copolymers may be selected e.g., from polydioxanone (PDS).

Particular embodiments can be found in WO 2019/020678.

In another embodiment, the active agent comprises at least one phytosanitary compound selected from pesticides, including fungicides and herbicides, insecticide, miticide, agent for exterminating rodents, insect repellents, fertilizers and biocontrol agents. Examples of phytosanitary compounds are cited in U.S. Pat. No. 9,420,780B2. The resulting foamed plastic composition is particularly useful for manufacturing plastic articles for agricultural field, such as agricultural films. In a particular embodiment, the foamed plastic composition contains both polymer-degrading enzyme and phytosanitary compound, so that the final agricultural plastic product can be degraded in land field after use.

In another embodiment, the active agents are selected from perfumes and/or odorous molecules.

Further aspects and advantages of the invention will be disclosed in the following examples, which should be considered as illustrative and do not limit the scope of this application. These Examples provide experimental data supporting the invention and means of performing the invention.

### EXAMPLES

### Example 1—Process of Producing a Plastic Composition of the Invention Comprising PET and an Enzyme Degrading PET

### A) Production Process by Foaming with Supercritical CO₂

Washed and colored flakes from bottle waste comprising 98% of PET (with a mean value of crystallinity of 34.5%) were foamed with supercritical CO₂ using a single screw extruder. Such extruder (diameter 30 mm—SCAMEX, FRANCE) comprises six heating zones (T) wherein the temperature may be independently controlled and regulated in each zone:
T1 and T2: zones before CO₂ injection,
T3 and T4: zones after CO₂ injection,
T5: mixing zone comprising a static mixer and
T6: die which comprises a die plate with an opening that can be adjusted according to the outlet pressure with maximum opening of 3 mm.

Temperatures in T1 to T3 are fixed to 180° C., 280° C. and 260° C. respectively, and the temperatures in T4 to T6 are listed in Table 3 below. The screw speed rate was fixed at 40 rpm.

Pressure in the final part of the mixing zone (T5) is measured by a pressure sensor and indicated in Table 3 (P4). CO₂ is pressurized and injected at constant flow using a syringe pump (Isco 260D, USA) between T2 and T3. Pressure, temperature and volumetric input of CO₂ (Q_{CO2}) are measured in the pump and indicated in Table 3. The obtained extrudates are immediately immersed in fresh water at about 15° C. and then cut into pieces of 2-3 mm with a knife mill. The obtained samples were then dried at ambient conditions during 48 h before analysis.

Two samples, S1 and S2, were prepared according to the indication detailed in Table 1 below indicating other experimental conditions used for samples preparation and porosity results. Qp is the polymer flow rate which was determined by weighing obtained sample. Q_{CO2} is the volume flow of injected CO₂. The mass flow rate of CO₂ relative to the total flow rate (w_{CO2}) is calculated using the density obtained by equation of state of Span and Wagner (R. Span et W. Wagner, A new equation of state for carbon dioxide covering the fluid region from the triple-point temperature to 1100 k at pressures up to 800 mpa. Journal of Physical and Chemical Reference Data, vol. 25(6), pp. 1509-1596, 1996). Tmat is the measured material temperature at the exit of the extruder.

The extrudate was either immersed in water bath (S1) or in water comprising enzyme bath (S2) containing approximately 4.3 g/l of same secreted recombinant LCC-ICCIG enzyme. LCC-ICCIG is a variant of LC-cutinase (Sulaiman et al., Appl Environ Microbiol. 2012 March), corresponding to the enzyme of SEQ ID N° 1 with the following mutations F208I+D203C+S248C+V1701+Y92G expressed as recombinant protein in Trichoderma reesei.

The obtained extrudates were rinsed with water, dried under ambient conditions and then cut into pieces of 2-3 mm with a knife mill. Both samples S1 and S2 exhibit a crystallinity of 16%.

TABLE 1
experimental conditions used for foamed plastic products preparation

| | T4 | T5 | T6 | Qp | Q_{CO2} | w_{CO2} | Cooling | ρₐₚₚ^{water} | ε_{T} |
|---|---|---|---|---|---|---|---|---|---|
| Sample | (° C.) | (° C.) | (° C.) | (g/min) | _{(ml/min)} | (%) | bath | (kg/m³) | (%) |
| S1 | 250 | 250 | 250 | 11.43 | 0.3 | 2.4 | water | 582.3 | 57 |
| S2 | 250 | 250 | 250 | 20 | 0.3 | 1.4 | water + enzyme | 627.9 | 42 |

B) Depolymerization Step

For each sample, 100 mg were respectively weighted and introduced in a 250 ml glass bottle containing 49 mL of 0.1 M potassium phosphate buffer (pH 8). The depolymerization was started by incubating each sample at 60° C. and 150 rpm in a Multitron pro (Infors HT, Switzerland).

The depolymerization rate of PET was determined via regular sampling. The samples were analyzed by Ultra High Performance Liquid Chromatography (UHPLC) for measuring the amount of terephthalic acid equivalent produced according to the method described herein. The AT equivalent concentration was determined by chromatography (UHPLC). If necessary, the samples were diluted in 100 mM potassium phosphate buffer, pH 8. One mL of samples or diluted samples were mixed with 1 mL of methanol and 100 μL of 6 N HCl. After homogenization and filtration through a 0.45 m syringe filter, 20 μL of sample were injected into the UHPLC, Ultimate 3000 UHPLC system (Thermo Fisher Scientific, Waltham, Mass.) including a pump module, a sampler automatic, a column thermostated at 25° C. and a UV detector at 240 nm. The terephthalic acid (AT) and the produced molecules (MHET and BHET) were separated using a gradient of methanol (30% to 90%) in 1 mM H2SO4 at 1 m/min through a HPLC Discovery HS C18 column (150 mm×4.6 mm, 5 m) equipped with a precolumn (Supelco, Bellefonte, Pa.). AT, MHET and BHET were measured according to standard curves prepared from commercially available AT and BHET and internally synthesized MHET. The AT equivalent is the sum of the measured TA and the TA equivalent in the measured MHET and BHET. The percentage of hydrolysis of samples S2 and Control2 was calculated based on the total amount of TA equivalent (TA+MHET+BHET) at a given time versus the total amount of TA determined in the initial sample.

After 30 hours, S2 has shown a percentage of depolymerization of about 85%, whereas S1 has not shown any detectable depolymerization. The results indicate that some enzymes have been fixed in the cell structures of the foamed plastic material comprising PET during the cooling phase.

### Example 2—Process of Producing a Plastic Composition of the Invention Comprising PLA and an Enzyme Degrading PLA

### A) Production Process by Foaming with Chemical Foaming Agent

Polylactic acid (PLA) 4043D (pellet form provided from NatureWorks) was foamed using a twin-screw extruder Leistritz ZSE 18 MAXX was used. It comprises nine successive heating zones (Z1-Z9) and a head (Z10) wherein the temperature may be independently controlled and regulated in each zone. A chemical foaming agent (CFA) HYDROCEROL BIH 40 masterbatch provided by Clariant was used.

PLA and CFA were dried in desiccator during 14 h at 60° C. and 45° C. respectively. 95% by weight of PLA pellets and 5% of the CFA masterbatch were dry blended and added to the hopper of a gravimetric feeder to be introduced to the extruder. A total flow rate of 2 kg/h was obtained. Temperature profile all along the screw is described in Table 2. The screw speed rate was set to 100 rpm.

TABLE 2
Temperature profile of extruder used for sample named S3

| Zone | Z1 | Z2 | Z3 | Z4 | Z5 | Z6 | Z7 | Z8 | Z9 | Z10 (head) |
|---|---|---|---|---|---|---|---|---|---|---|
| T° C. | 140° C. | 140° C. | 150° C. | 170° C. | 170° C. | 170° C. | 170° C. | 170° C. | 170° C. | 165° C. |

The molten polymer arrived in the screw head (Z10) comprising a die plate with one hole of 3.5 mm. The resulting extrudate was immediately immersed in a container with 1 L of commercially available enzyme solution Savinase® 16 L from Novozymes (known to be able to degrade PLA—concentrated at approximately 4.5%) with temperature of 15° C., then pulled and wound manually. 24 hours later, the sample was washed with water and dried at ambient conditions (20° C. and 40% humidity) for 48 hours. The sample was then granulated with a rotary cutter into 2-3 mm solid pellets (S3—crystallinity of 2%). As a control, another sample (S4) was also foamed in the same manner except that the resulting extrudate was immersed in water deprived of enzyme.

### B) Depolymerization Step

100 mg of each alloy have been weighted and introduced in cellulose dialysis tubing. This latter was introduced in a glass bottle containing 50 mL of Tris 100 mM buffer pH 9.5, incubated at 45° C. and 150 rpm.

Measurements of degradation percentages of the alloy have been performed by UHPLC according to the protocol below. 1 mL samples have been regularly taken. After filtration on 0.22 m filter, samples were loaded on UHPLC (Ultimate 3000 UHPLC system (Thermo Fisher Scientific, Inc. Waltham, Mass., USA) including a pump module, an autosampler, a column oven thermostated at 50° C., and a UV detector at 210 nm) to monitor the liberation of lactic acid and dimers of lactic acid. Lactic acid and dimers of lactic acid were separated using column Aminex HPX-87H and a mobile phase H2SO4 5 mM, at a flow rate of 0.5 mL·min-1. Injection was 20 μL of sample. Lactic acid (LA) and dimers of lactic acid (DP2) were measured according to standard curves prepared from commercial lactic acid (Sigma-Aldrich L1750-10G) and in-house synthetized dimers of lactic acid in the same conditions than samples.

The degradation percentage was calculated according to the following molar ratio of LA plus the LA contained in DP2 at a given time versus the theoretical LA contained initially in the PLA.

After 24 hours, S3 has shown a degradation rate of 76%, whereas S4 has not shown any significant degradation. The results indicate that some enzymes have been fixed in the cell structures of the foamed plastic material comprising PLA during the cooling phase.

### Example 3—Process of Producing a Plastic Composition of the Invention Comprising PLA and an Enzyme Degrading PLA and Validation of the Amount of Enzyme Entrapped in Ion in the Foamed Plastic Composition

### A) Production Process by Foaming with a Chemical Foaming Agent

Polylactic acid (PLA) 4043D (pellet form provided from NatureWorks) was foamed using a twin-screw extruder Leistritz ZSE 18 MAXX. It comprises nine successive heating zones (Z1-Z9) and a head (Z10) wherein the temperature may be independently controlled and regulated. Sodium Bicarbonate provided by Sigma Aldrich was used as the chemical foaming agent.

PLA was dried in a desiccator during 8 h at 80° C. PLA pellets were introduced in the principal hopper (Z0) and Sodium Bicarbonate was introduced in Z4 via a side feeder using a gravimetric doser to form a composition containing 98% by weight of PLA and 2% by weight of Sodium Bicarbonate based on the total weight of the mixture. A total flow rate of 2 kg/h was obtained. Temperature profile all along the screw is described in Table 3. The screw speed rate was set to 150 rpm.

TABLE 3
Temperature profile of extruder used for sample named S5 and S6

| Zone | Z1 | Z2 | Z3 | Z4 | Z5 | Z6 | Z7 | Z8 | Z9 | Z10 (head) |
|---|---|---|---|---|---|---|---|---|---|---|
| T° C. | 185° C. | 185° C. | 175° C. | 150° C. | 150° C. | 175° C. | 175° C. | 175° C. | 150° C. | 175° C. |

The molten polymer arrived in the screw head (Z10) comprising a die plate with one hole of 3.5 mm. The resulting extrudate was immediately immersed in a bath of enzymatic solution comprising either 27 g/L or 13 g/L of Savinase® (and obtained through diafiltration and concentration of commercial solution of Savinase® from Novozymes), in order to produce samples S5 and S6, respectively. The temperature of the enzymatic solutions was 20° C. After immersion, extrudate was pulled and granulated using an automatic blade granulator into 2-3 mm solid pellet. The relative humidity of samples (i.e., the amount of enzymatic solution incorporated in the foamed samples) was measured by an infrared balance before being subjected to a drying step during 48 hours at 45° C. with a vacuum at 40 mbar. A control sample was also foamed in the same conditions except that the foamed PLA was immersed in water without enzyme (Sample S7) and then dried during 48 hours at 45° C. with a vacuum at 40 mbar.

The amount of entrapped enzyme inside the foamed PLA samples S5 and S6 was evaluated on dried samples based on the amount of enzymatic solution incorporated and is evaluated with the following formula

$$Amount of enzyme ( µg ) per mg of PLA in the dried composition = \frac{\% of enzyme in the dried composition \times 100 \%}{\% of PLA in the dried composition} \times 10$$

### Wherein:

$$\% of enzyme in the dried composition = \frac{\begin{matrix}\% enzyme in enzymatic solution \times \% Humidity \\ of the plastic composition after immersion\end{matrix}}{\frac{100 \% - \% of water in the humid composition}{100 \%}}$$

### And

$$\% of PLA in the dried composition = \frac{100 - \% Humidity of the plastic composition after immersion}{\frac{100 \% - \% of water in the humid composition}{100 \%}}$$

And wherein the % water in the humid composition=% water in enzymatic solution×% Humidity of the plastic composition after immersion.

Results are shown in Table 4 below.

TABLE 4
Humidity percentage and amount of enzyme in the PLA
plastic composition of the invention (samples S5 and S6).

| | Enzymatic | Humidity of | Amount of enzyme |
|---|---|---|---|
| | solution | the plastic | (μg) per mg of |
| | concentration | composition | PLA in the dried |
| Samples | (g/L) | after immersion | composition |
| S5 | 27 | 22% | 7 |
| S6 | 13 | 14% | 2 |

### B) Depolymerization Step

A total of 100 mg of sample S5, S6 and S7 have been introduced in a dialysis tubing cellulose membrane. The latter were introduced in glass bottle containing 50 mL of Tris 100 mM buffer pH 9.5, incubated at 45° C. under agitation at 150 rpm which enables to start the degradation process of the foamed composition of the invention.

The control sample S7 was also used in an additional experiment, wherein 2 μg of Savinase® enzyme per mg of PLA were added in the dialysis tubing membrane (Sample S8).

The degradation percentage of each sample has been determined by UHPLC according to the method described in example 2 and results are shown in Table 5.

TABLE 5
Degradation percentage of samples S5-S8 after
4.5 hours of reaction.

| | Amount of enzyme | Amount of enzyme | Degradation |
|---|---|---|---|
| | (μg) per mg of PLA | (μg) per mg of PLA | percentage |
| | in the foamed | added in the dialysis | after 4.5 h |
| Sample | composition | tubing membrane | of reaction |
| S5 | 7 | 0 | 49.5% |
| S6 | 2 | 0 | 26% |
| S7 | 0 | 0 | 0% |
| S8 = S7 + | 0 | 2 | 23% |
| “external” | | | |
| enzyme | | | |

After 4.5 hours of reaction, S5 and S6 show respectively 49.5% and 26% of depolymerization, whereas S7 (deprived of enzyme) shows no degradation. This result confirms that higher depolymerization percentage could be obtained by increasing the enzyme concentration in the bath. In addition, we observed that S8 (deprived of enzyme) shows similar degradation rate when an equivalent enzyme concentration is added in the reaction medium. This confirms the estimated amount of enzyme entrapped in the foamed PLA and demonstrates that enzyme activity is not affected by this introduction process.

### Example 4—Process of Producing a Foamed Masterbatch Composition of the Invention Comprising PLA and Enzyme, and a Plastic Article Made with Said Masterbatch Composition

### A) Masterbatch Composition Preparation

A foamed PLA masterbatch composition of the invention (S9) containing Savinase® (protease known to have a PLA-degrading activity) and PLA was prepared according to same protocol as described in Example 2. For this sample preparation, the extrudate was immersed immediately after extrusion in a bath containing 2 L of enzymatic solution containing a diafiltrated and concentrated solution of Savinase® at a concentration of 19 g/L of Savinase®.

S9 was then dried during 48 hours at 45° C. with a vacuum at 40 mbar.

The residual humidity after enzyme incorporation was measured by infrared balance and evaluated at 6,63%. The amount of enzyme in the masterbatch composition was thus evaluated (by following the formula in Example 3) at 13 μg per mg of PLA. The masterbatch thus comprises about 1.3% of enzyme based on the total weight of the masterbatch composition.

### B) PLA Calcium Carbonate Compound Preparation

The same extruder described in Examples 1 and 2 was used to prepare compound containing PLA 4043D and 5.5% by weight of Calcium Carbonate (Smartfill 55 OM from Omya) based on the total weight of the mixture. The PLA was introduced in the principal hopper using a gravimetric dosing system and the Calcium Carbonate was introduced in the Z7 via a side feeder using a gravimetric dosing system. The total flowrate was set to 3 kg/h and screw speed rate to 150 rpm. Temperature profile set corresponds to 185° C. in the five first zones and 175° C. in the five last zones. The molten polymer arrived in the screw head (Z10) comprising a die plate with one hole of 3.5 mm and was immediately immersed in a 2 m long coldwater bath (10° C.). The resulting extrudate was granulated into 2-3 mm solid pellets to obtain compounds containing 94.5% wt of PLA 4043D and 5.5% wt of Calcium Carbonate.

### C) Preparation of Enzymated PLA Plastic Articles by Using a Foamed PLA Masterbatch of the Invention

A co-rotating twin-screw extruder has been used for the production of enzymated polylactic acid compositions (“Haake MiniLab II ThermoFisher”). This compounding machine comprised successively a manual feed element, two co-rotating screw and the head of the twin screw.

Compositions (comprising 10% of S9 and 90% of PLA/CaCO3 Compound by weight if the total composition) were mixed together by manual shaking before introduction in the compounding machine. The mix was then introduced in the feeding zone and pushed into the screw extruder applying manual pressure. The mix went through co-rotating screws, using a rotation speed of 80 rpm. The temperature was fixed to 165° C. The mix arrived in the screw head, comprising one hole of 0.4 mm in diameter, wherein the mix was pushed in order to form strip shapes that was immediately immersed in a cold-water bath (20° C.). This extrudate was then cut with cutting pliers to obtain a granulated form. The extrudate comprises about 0.14% of enzyme based on the total weight of the composition.

The prepared composition was depolymerized in the same conditions as described in example 3-B) and shows about 6% depolymerization after 5.8 days of degradation.

The result indicates that the enzyme included in the foamed masterbatch composition retains activity, as well as in the plastic article produced from said masterbatch.

1-30. (canceled)

31. A foamed plastic composition comprising at least one polymer and at least one active agent selected from enzymes and microorganisms having a polymer degrading activity, wherein said foamed plastic composition is at least partially coated with the active agent, wherein the active agent of the foamed plastic composition has been deposited on the walls and/or cell structures of the foamed plastic material by immersion of the foamed plastic material in a cooling liquid comprising said active agent after the foaming step.

32. The foamed plastic composition according to claim 31, wherein the at least one polymer is selected from polyolefins, aliphatic and semi-aromatic polyesters, polyamides, polyurethanes, vinyl polymers, polyethers, ester-ether copolymers or thermoplastic elastomers and derivatives thereof.

33. The foamed plastic composition according to claim 31, which is a masterbatch composition comprising at least one polymer and at least one active agent, wherein the foamed masterbatch composition is at least partially coated with the active agent and comprises between 0.1% and 10% or between 11% and 90% of active agent by weight of the foamed plastic composition.

34. The foamed plastic composition according to claim 33, wherein the masterbatch composition comprises between 0.001 and 30 wt % of pure degrading enzyme.

35. The foamed plastic composition according to claim 33, wherein the at least one polymer is selected from PCL, PBAT, PBSA, PBS, PBA, PGA, PLA, PLGA and PHA.

36. The foamed plastic composition according to claim 33, wherein the at least one polymer is selected from PCL and PLA.

37. A process for incorporating an active agent within cell-structures of a foamed plastic composition comprising of at least one polymer, wherein the process comprises the steps of:
a) foaming a plastic material comprising at least one polymer; and subsequently
b) cooling the foamed plastic material by contacting said foamed plastic material with a cooling liquid comprising said active agent.

38. The process according to claim 37, further comprising a step of granulation after the cooling step.

39. The process according to claim 37, wherein the foaming step is performed at a temperature above the crystallization temperature (Tc) of at least one polymer of the plastic material.

40. The process according to claim 37, wherein the foaming step is performed with a physical foaming agent selected from gas.

41. The process according to claim 37, wherein the foaming step is performed with a chemical foaming agent selected from the group consisting in citrate, carbonate or a mixture thereof.

42. The process according to claim 37, wherein the step of cooling is implemented less than 30 seconds after the foaming step, by contacting the plastic material with a cooling liquid at a temperature below the crystallization temperature (Tc) of at least one polymer of the plastic material.

43. The process according to claim 37, wherein the foaming step is performed in an extruder.

44. A method for manufacturing a plastic article comprising at least one polymer, the method comprising:
a) providing a masterbatch composition according to claim 33, and
b) mixing said masterbatch composition with a plastic material comprising at least one polymer, different or similar to the polymer of the masterbatch and shaping said mixture of plastic composition and masterbatch into a plastic article.

45. The method of claim 44, wherein the step b) comprises mixing between 0.1 and 20% by weight of said masterbatch composition with 80% to 99.9% by weight of a plastic material, based on the total weight of the mix.

46. The method of claim 44, wherein said masterbatch composition comprises at least one polyester selected from PLA, PCL, PBS, PBSA or PBAT and an active agent selected from enzymes and microorganisms suitable to degrade PET, and wherein said plastic material comprises PET.

47. The method of claim 46, wherein the active agent is selected from esterase, cutinase and lipase.

48. The method of claim 44, wherein said masterbatch composition comprises at least one polyester selected from PLA, PCL, PBS, PBSA or PBAT and an active agent selected from enzymes and microorganisms suitable to degrade PLA, and wherein said plastic material comprises PLA.

49. The method of claim 48, wherein the active agent is a protease.

50. A method for manufacturing a plastic article comprising at least one polymer, the method comprising:
a) providing a foamed plastic composition according to claim 31; and
b) shaping said plastic composition into a plastic article.

51. A method for manufacturing a multicomponent plastic article comprising at least one polymer, the method comprising:
a) providing a plastic material comprising at least one polymer,
b) providing a masterbatch composition of claim 33,
c) shaping said multicomponent plastic article using a co-extrusion, coinjection and/or extrusion coating process.


SEQUENCE LISTING (1 sequence)

SEQ ID NO: 1 - protein, 258 aa, ARTIFICIAL SEQUENCE
  CUTINASE
SNPYQRGPNPTRSALTADGPFSVATYTVSRLSVSGFGGGVIYYPTGTSLTFGGIAMSPGYTADASSLAWLGRRLASHGFVVLVINTNSRFDYPDSRASQLSAALNYLRTSSPSAVRARLDANRLAVAGHSMGGGGTLRIAEQNPSLKAAVPLTPWHTDKTFNTSVPVLIVGAEADTVAPVSQHAIPFYQNLPSTTPKVYVELDNASHFAPNSNNAAISVYTISWMKLWVDNDTRYRQFLCNVNDPALSDFRTNNRHCQ